(19) United States
(12) Patent Application Publication
(10) Pub. No.: US 2003/0231050 A1
(43) Pub. Date: Dec. 18, 2003

(54) Method of forming a reference voltage from a J-fet

(75) Inventors: Frantisek Sukup, Roznov (CZ); Josef Halamik, Roznov (CZ)

Correspondence Address: James J. Stipanuk, Semiconductor Components Industries, L.L.C., Patent Administration Dept - MD/A700, P.O. Box 62890, Phoenix, AZ, 85082-2890, US

(73) Assignee: Semiconductor Components Industries, LLC

(21) Appl. No.: 10/171,362

(22) Filed: Jun. 14, 2002

(51) Int. Cl. G05F 1/10

(52) U.S. Cl. 327/540

(57) ABSTRACT

A voltage reference circuit (20) has two J-FET transistors (22,25) that are formed to cooperate to supply a reference voltage that is stable over a wide range of supply voltages and temperatures. One transistor operates in the drain current saturation mode and the other transistor operates in a triode mode.

### BACKGROUND OF THE INVENTION

The present invention relates, in general, to electronics, and more particularly, to methods of forming semiconductor devices and structures.

In the past, the semiconductor industry utilized various techniques for forming voltage references. Typically, a voltage source is connected to a circuit that clamps the value of an output voltage to a particular value. FIG. 1 schematically illustrates a typical voltage reference circuit 10 that has a voltage source 11, and a voltage reference output 14. The voltage from voltage source 11 is applied to a zener diode 13 through a series resistor 12 in order to form the reference voltage on output 14. Zener diode 13 clamps the voltage on output 14 to the zener voltage of diode 13. The reference voltage from prior voltage reference circuits, such as circuit 10, varies as the value of the voltage from source 11 varies and also varies with temperature. Often, the reference voltage value can vary greater than five percent (5%) due to temperature and supply voltage variations.

Accordingly, it is desirable to have a voltage reference that provides a stable reference voltage that varies less than approximately five percent (5%) over a wide range of voltage supply variations and temperature variations.

### BRIEF DESCRIPTION OF THE DRAWINGS

FIG. 1 is a schematic illustrating a prior art voltage regulator;

FIG. 2 schematically illustrates an embodiment of a portion of a circuit that forms a reference voltage in accordance with the present invention;

FIG. 3 schematically illustrates an alternate embodiment of the circuit of FIG. 2 in accordance with the present invention;

FIG. 4 schematically illustrates another alternate embodiment of the circuit of FIG. 2 in accordance with the present invention;

FIG. 5 schematically illustrates another embodiment of a portion of a circuit that forms a reference voltage in accordance with the present invention;

FIG. 6 schematically illustrates an alternate embodiment of the circuit of FIG. 5 in accordance with the present invention; and

FIG. 7 schematically illustrates another alternate embodiment of the circuit of FIG. 5 in accordance with the present invention.

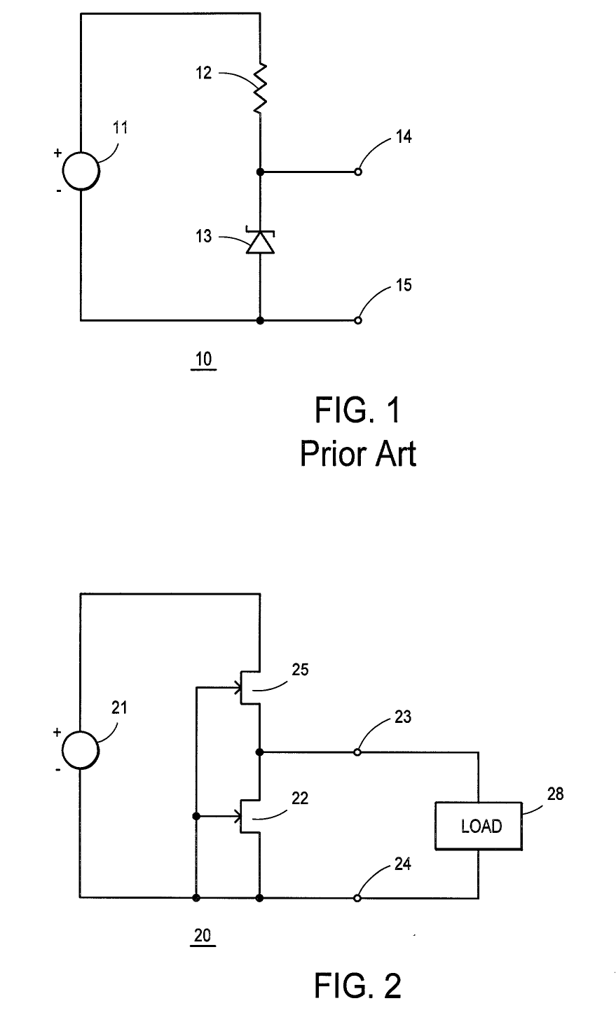

For simplicity and clarity of illustration, elements in the figures are not necessarily to scale, and the same reference numbers in different figures denote the same elements. Additionally, descriptions and details of well known steps and elements are omitted for simplicity of the description.

### DETAILED DESCRIPTION OF THE DRAWINGS

The present description includes a method of forming a reference voltage that is substantially stable over a wide range of voltage source and temperature variations.

FIG. 2 schematically illustrates a portion of an embodiment of a circuit 20 that forms a reference voltage having a stable output voltage over a wide range of temperature and voltage variations. Circuit 20 includes a voltage source 21 that provides a first voltage value on a first terminal and a second voltage value on a second terminal. In some embodiments, circuit 20 is a portion of a larger circuit that provides source 21 to circuit 20. Circuit 20 includes a first J-FET transistor 25 and a second J-FET transistor 22 that are coupled to provide a reference voltage on a reference output 23. Transistor 25 receives a first voltage value from source 21 and develops a through current or reference current that is used to supply a load current to load 28 and a remainder current that is received by transistor 22. Both of transistors 22 and 25 are J-FET transistors and preferably are N-Channel J-FET transistors. Transistor 25 has a drain connected to a first terminal of source 21, a source connected to output 23, and a gate connected to a voltage return 24. Transistor 22 has a drain connected to the source of transistor 25, to output 23 and the drain of transistor 25, and a gate connected to return 24. Since transistors 22 and 25 are J-FET transistors, it will be noted that the transistors can be formed symmetrically, thus, the source and drain may be interchangeable. In such a case, the source and drain nomenclature would designate traditional current flow and would not represent physical transistor characteristic limitations. In the preferred embodiment, transistors 22 and 25 are formed symmetrically.

Transistors 22 and 25 are formed to ensure that transistor 25 operates in a drain current saturation mode, often referred to as operating in a saturation region or saturation mode, and to ensure that the temperature coefficients of the reference current and remainder current minimize the temperature variation of the reference voltage formed at output 23. Because transistor 25 operates in the saturation mode, the reference current through transistor 25 is independent of the source-to-drain voltage of transistor 25 as long as the voltage supplied by source 21 is sufficient to ensure the drain-to-source voltage remains above the voltage required for saturation. Transistor 22 is formed to operate in the triode mode and to sink the remainder current provided by transistor 25. The reference current flowing through transistor 25 has a temperature coefficient or variation with temperature. As will be seen hereinafter, transistor 22 is formed to have a remainder current temperature coefficient that varies negatively relative to that of transistor 25 at the reference current value.

The length of transistor 25 is selected to ensure that the reference current provides the desired load current for load 28 and to ensure that transistor 25 operates in the saturation mode. The width of transistor 25 is selected to provide the required reference current and to occupy a small space for the required current. Once the length and width of transistor 25 is selected, the length of transistor 22 is selected to sink the remainder current from transistor 25, to ensure transistor 22 operates in the triode mode, and to minimize variations in the value of the reference voltage on output 23 that result from variations in temperature and variations in the voltage supplied by source 21. The width of transistor 22 is selected to be approximately the same as that of transistor 25 in order to assist in matching the temperature variations of transistors 22 and 25. If the widths of transistors 22 and 25 are different, one transistor may have a different variation with temperature thereby causing the reference voltage to have a greater variation with temperature.

It has been found that varying the ratio of the length of transistor 25 to the length of transistor 22 provides a stable reference voltage on output 23 over a wide range of temperature variations. Consequently, once the length of transistor 25 is selected to ensure saturation mode operation, the length of transistor 22 is selected to provide the desired thermal characteristics. Typically, the rate of change of the reference voltage with temperature for a particular length ratio has minimum near a temperature of approximately thirty degrees Celsius (30° C.), and is symmetrical about that temperature. Thus, the length of transistor 22 can be initially selected to provide a minimum variation at that temperature. Increasing the length ratio, for example by shortening the length of transistor 22, generally increases the rate of-change in the output voltage value due to increased temperature, while decreasing the ratio, for example lengthening the length of transistor 22, generally decreases the change in output voltage value due to increased temperature values. The exact length ratio that provides the smallest reference voltage variation with temperature can be determined by simulation or other numerical analysis techniques. In a typical design situation, the circuit is simulated and the length of transistor 22 is varied until the desired temperature and voltage characteristics are achieved.

Transistor 25, and preferably transistor 22, are also formed to have a gate-to-source pinch-off voltage value that is less than the minimum instantaneous voltage value supplied by source 21 in order to ensure that the value of the reference voltage remains substantially stable as the value of the voltage applied by source 21 varies. In the preferred embodiment, the pinch-off voltage of each of transistors 22 and 25 individually is at least approximately thirty (30) percent less than the minimum instantaneous value of the voltage provided by source 21. The maximum value of the voltage value supplied by source 21 generally can vary from a just greater than the pinch-off voltage of transistor 25 to a value that is three hundred to five hundred times the pinch-off voltage value. Consequently, source 21 can be a variety of sources including an unregulated and poorly filtered source as long as the instantaneous value of the voltage supplied by source 21 is greater than the value of the pinch-off voltage of transistor 25. Thus, circuit 20 provides a very good supply voltage rejection ratio. It should be noted that the maximum voltage supplied by source 21 should not exceed the breakdown voltage of transistors 22 and 25.

The value of the reference current provided by transistor 25 is limited. Once a particular design for transistors 22 and 25 is formed, increases in the value of the reference current can result in a decrease in the value of the reference voltage supplied at output 23. Consequently, the load current provided to load 28 generally is small, and the majority of the reference current is the remainder current sunk by transistor 22. Preferably, load 28 is primarily a capacitive load presented by the gates of MOS type transistors and the load current is primarily leakage current of the MOS transistors. Thus, once the load current charges the capacitance of the MOS gates, the average load current provided by transistor 25 is a small portion of the reference current provided by transistor 25. However, if a particular load requires a large current, the large current may be included in the initial current value for which transistor 25 is designed. Typically, the remainder current received by transistor 22 is between about ninety percent (90%) and ninety-five percent (95%) percent of the reference current, and preferably is substantially equal to the reference current supplied by transistor 25.

In general, the value of the reference voltage on output 23 depends on the pinch-off voltage of transistor 25. Varying the pinch-off voltage generally varies the reference voltage. Often, the pinch-off voltage is determined by process parameters such as the thickness of layers used to form the body of transistors 22 and 25. Also, the pinch-off voltage can be changed slightly by using a different width for both of transistors 22 and 25, thus, the reference voltage can also be changed slightly. For example, a transistor 25 having a fifteen micron width had a pinch-off voltage of approximately thirteen volts (13V) and formed a reference voltage of about 1.405 volts. Varying the width of the transistor to about nine microns changed the pinch-off voltage to about nine volts (9V) and the reference voltage to about 1.22 volts, resulting in a reference voltage change of about thirteen percent (13%).

In one example, circuit 20 has a D.C. voltage source 21 that is formed to generate a voltage of about ten volts (10V). Transistors 25 and 22 are formed to have a pinch-off voltage of approximately nine volts (9V) The length of transistor 25 is formed to be approximately one hundred fifty microns (150 micro-meters) to ensure that transistor 25 operates in the saturated mode and to provide the load current required by load 28. The width of transistor 25 is formed to be about fifteen microns (15 micro-meters). The width of transistor 22 is formed to be approximately the same as the width of transistor 25. The length of transistor 22 is formed to sink the current provided by transistor 25. Then the length of transistor 22 is adjusted to provide a length ratio to the length of transistor 25 in order to provide the desired temperature variation. The length of transistor 22 is formed to be approximately fifty microns (50 micro-meters) to provide a length ratio of one-third (⅓). The resulting reference voltage on output 23 is approximately 1.405 volts. As the value of the voltage from source 21 varies from ten volts to ninety volts, the reference voltage on output 23 varies approximately 0.017 volts or about 1.2 percent (1.2%). The reference voltage varies only four milli-volts (4 mV) as the temperature varies from zero degrees Celsius (0° C.) to one hundred fifty degrees Celsius (150° C.). Thus, the temperature variation is about 0.3 percent (0.3%).

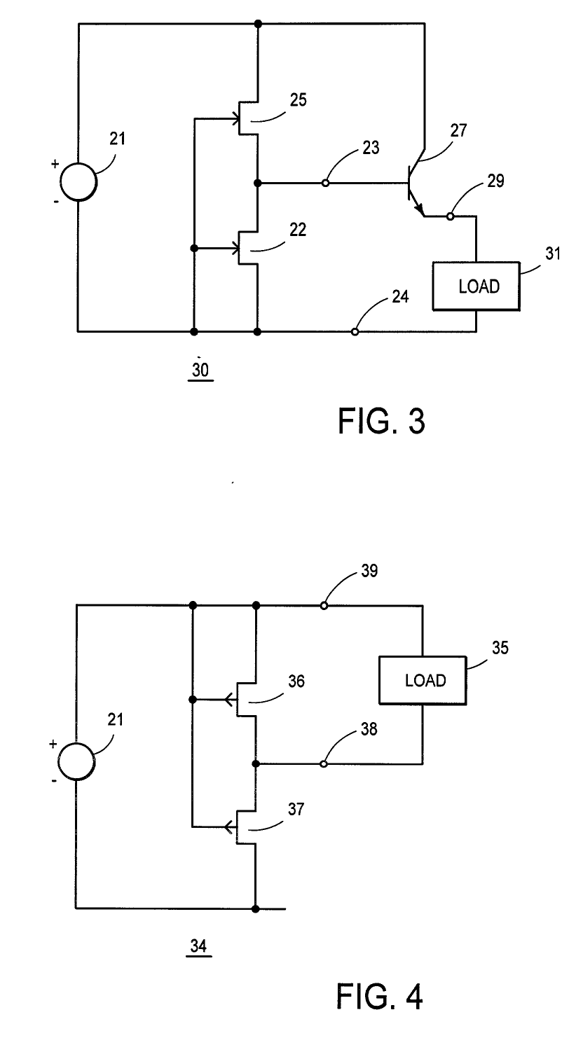

FIG. 3 schematically illustrates a circuit 30 that is an alternate embodiment of circuit 20 shown in FIG. 2. Circuit 30 includes a bipolar current boost transistor 27 that provides additional load current for the voltage reference circuit that includes transistors 22 and 25. Transistor 27 is connected as an emitter follower to provide a boosted reference voltage at a boosted output 29. Circuit 30 provides an increased load current through transistor 27 to a load 31. Because of the additional current provided by transistor 27, load 31 can sink more current than load 28. The reference voltage on output 29 is equal to the reference voltage on output 23 minus the base-emitter voltage drop of transistor 27. Additional thermal dependency resulting from the base-emitter voltage variations can be compensated for by setting the base-emitter inverse thermal characteristic of the reference voltage. To facilitate the additional load current, transistor 27 has a base connected to output 23, a collector connected to the most positive terminal of source 21, and an emitter connected to output 29.

FIG. 4 schematically illustrates a circuit 34 that is an alternate embodiment of circuit 20 shown in FIG. 2. Circuit 34 utilizes a P-channel J-FET transistor 36 and a P-channel J-FET transistor 37. Transistors 36 and 37 are formed to operate similarly to transistors 22 and 25 of FIG. 2. Transistor 37 operates in the saturation mode and transistor 36 operates in the triode mode. However, because transistors 36 and 37 are P-channel, the gate of transistors 36 and 37 is connected to a terminal of voltage source 21 that provides the most positive voltage of source 21. Thus, transistor 37 functions similarly to and is formed similarly to first transistor 25, and transistor 36 functions similarly to and is formed similarly to second transistor 22. Transistor 37 has a drain connected to the most negative voltage terminal of source 21, a source connected to a reference output 38 and to a drain of transistor 36, and a gate connected to the most positive terminal of source 21. Transistor 36 has a source connected to the gate of transistor 36 and to the most positive terminal of source 21. A load 35 is connected between reference output 38 and a positive output terminal 39 that is also connected to the most positive terminal of source 21. It should be noted that a PNP boost transistor could be added to circuit 34 with a base connected to output 38, an emitter connected to load 35, and a collector connected to the most negative terminal of source 21.

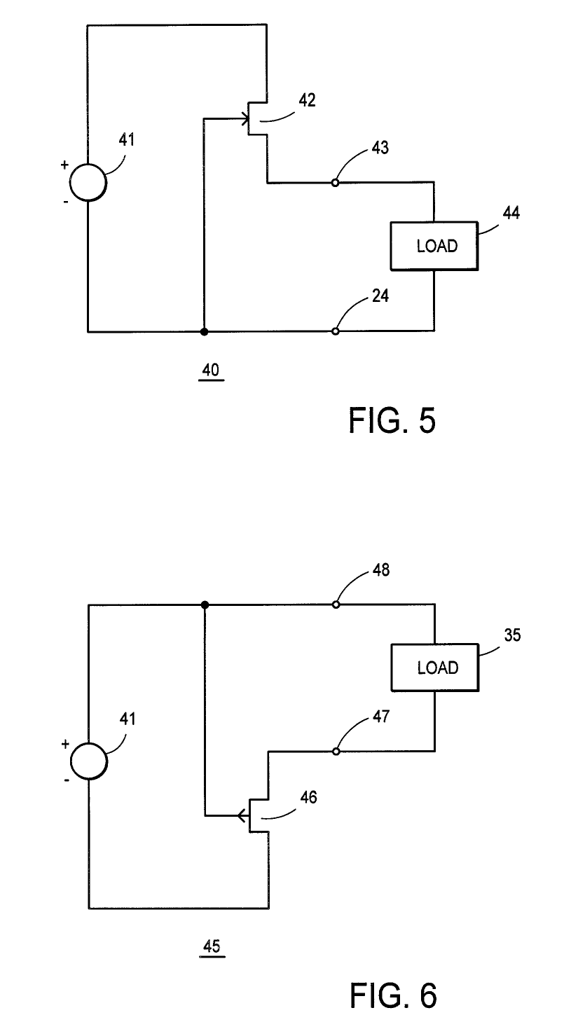

FIG. 5 schematically illustrates an embodiment of a portion of a circuit 40 that provides a reference voltage that is clamped at a desired value and has low noise in the reference voltage. Circuit 40 includes a voltage source 41 that provides a voltage for an N-channel J-FET transistor 42. Source 41 generally provides a regulated voltage such as a D.C. voltage. Often, the regulated voltage may be too large for a particular circuit to use, so a lower voltage is required. Circuit 40 provides the lower voltage with minimal noise. Transistor 42 receives the voltage from source 41, forms a stable reference voltage on a reference output 43, and provides the load current for load 28. Transistor 42 operates in the pinch-off mode, and is formed to have a pinch-off voltage that is less than the minimum voltage value supplied by source 41 to ensure that transistor 42 operates in the pinch-off mode. When the voltage supplied by source 41 exceeds the pinch-off voltage of transistor 42, transistor 42 clamps output 43 to a precise voltage value that has very low noise. The value of the reference voltage provided on output 43 is approximately equal to the value of the pinch-off voltage of transistor 42. Transistor 42 is designed to have a width and length that provides the desired average load current for load 28 and ensures that transistor 42 operates in the pinch-off mode. The load current must be sufficiently low to ensure that transistor 42 operates in the pinch-off mode. It should be noted that changing the length and width of transistor 42 may also change the pinch-off voltage and the resulting reference voltage. Transistor 42 could be viewed as operating as a resistor and since a resistor has very low noise, the voltage on output 43 also has very low noise. Transistor 42 has a drain connected to the most positive terminal of source 41, a gate connected to the most negative terminal of source 41, and a source that is connected to output 43 and load 28. Because transistor 42 operates in the pinch-off mode, the average load current supplied by transistor 42 is small and is typically used to supply leakage current to the gates of MOS transistors in load 28.

FIG. 6 schematically illustrates a portion of an embodiment of a circuit 45 that is an alternate embodiment of circuit 40 shown in FIG. 5. Circuit 45 includes a P-channel J-FET transistor 46 that functions similarly to transistor 42 shown in FIG. 5. Transistor 46 operates in the pinch-off mode and has a drain connected to the most negative voltage of source 41, a gate connected to the most positive voltage terminal 48 of source 41, and a source connected to a reference output 47 and to load 35.

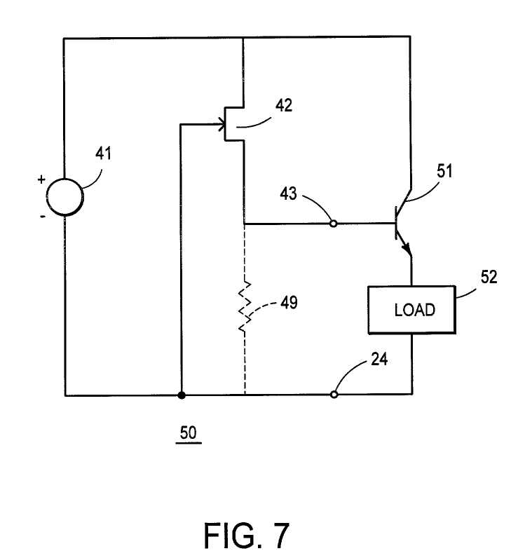

FIG. 7 schematically illustrates a portion of an embodiment of a circuit 50 that is an alternate embodiment of circuit 40 shown in FIG. 5. Circuit 50 utilizes a current boost voltage follower transistor 51 that functions similarly to transistor 27 shown in FIG. 3. Transistor 51 receives the reference voltage from output 43 and supplies a voltage to a load 52 that is the reference voltage minus the base-to-emitter voltage of transistor 51. Transistor 51 has a base connected to output 43, a collector connected to the drain of transistor 42, and an emitter connected to load 52. In some embodiments, a load resistor 49, illustrated by dashed lines, may be added to sink the current provided by transistor 42. Transistor 42 must be designed to provide the current required by resistor 49 and still remain operating in the pinch-off mode.

While the invention is described with specific preferred embodiments, it is evident that many alternatives and variations will be apparent to those skilled in the semiconductor arts. More specifically the invention has been described for particular P-channel and N-channel J-FET transistors having certain source and drain connections. However, J-FET transistors can be formed symmetrically, thus, the source and drain may be interchangeable. In such a case, the source and drain nomenclature would designate traditional current flow and would not represent physical transistor characteristic limitations.

1. A method of forming a reference voltage comprising:
forming a voltage supply to generate a first voltage value on a first terminal, and a second voltage value on a second terminal;
forming a first J-FET transistor to receive the first voltage value and operate in a drain current saturation mode to provide a reference voltage at a reference output; and
forming a second J-FET transistor to receive the second voltage value and the reference voltage, and operate in a triode mode and to receive a remainder current from the first J-FET transistor.

2. The method of claim 1 further including forming the first J-FET transistor and the second J-FET transistor as N-Channel transistors and forming the voltage supply to generate the first voltage value greater than the second voltage value.

3. The method of claim 1 further including forming the first J-FET transistor and the second J-FET transistor as P-Channel transistors and forming the voltage supply to generate the second voltage value greater than the first voltage value.

4. The method of claim 1 further including coupling a control electrode of the first J-FET transistor to a control electrode of the second J-FET transistor and to receive the second voltage value.

5. The method of claim 1 further including forming the first J-FET transistor with a first length that generates a first current flow through the first J-FET transistor and forming the second J-FET transistor with a second length that generates a second current flow through the second J-FET transistor wherein the first current flow is substantially equal to the second current flow.

6. The method of claim 5 further including forming the second J-FET transistor with a length that limits thermal variations of the reference voltage to less than approximately five percent.

7. The method of claim 1 further including forming the first J-FET transistor to have a pinch-off voltage value that is less than a value of the first voltage value minus the second voltage value.

8. The method of claim 7 wherein the step of forming the first J-FET transistor to receive the first voltage value and the step of forming the second J-FET transistor to receive the second voltage value includes coupling a first current electrode of the first J-FET transistor to receive the first voltage value, coupling a second current electrode of the first J-FET transistor to the reference output, and coupling a control electrode of the first J-FET transistor to receive the second voltage value and to a control electrode of the second J-FET transistor and further including coupling a first current electrode of the second J-FET transistor to receive the second voltage value and coupling a second current electrode of the second J-FET transistor to the reference output.

9. A method of forming a reference voltage comprising:
forming a voltage supply to generate a first voltage value on a first terminal, and a second voltage value on a second terminal;
coupling a first current electrode of a J-FET transistor to the first terminal and a second current electrode of the J-FET transistor to a first terminal of load; and
coupling a control electrode of the J-FET transistor and a second terminal of the load to the second terminal of the voltage supply and forming the voltage supply to generate a voltage that is greater than a pinch-off voltage of the J-FET transistor.

10. The method of claim 9 wherein the step of coupling the first current electrode of the J-FET transistor includes forming the J-FET transistor as an N-Channel transistor and forming the voltage supply to generate the first voltage value greater than the second voltage value.

11. The method of claim 9 wherein the step of coupling the first current electrode of the J-FET transistor includes forming the J-FET transistor as a P-Channel transistor and forming the voltage supply to generate the second voltage value greater than the first voltage value.

12. The method of claim 9 wherein coupling the control electrode of the J-FET transistor includes coupling the J-FET transistor to operate in a pinch-off mode.

13. A method of forming a voltage reference comprising:
forming a first J-FET transistor to operate in a drain current saturation mode; and
forming a second J-FET transistor to operate in a triode mode and forming the second J-FET transistor cooperatively coupled to the first J-FET transistor to generate a reference voltage at a node coupled to a first current electrode of the first J-FET transistor and to a first current electrode of the second J-FET transistor.

14. The method of claim 13 further including coupling a voltage source to supply a first voltage value to the first J-FET transistor and a second voltage value to the second J-FET transistor.

15. The method of claim 14 wherein coupling the voltage source includes coupling the voltage source to supply the first voltage value greater than the second voltage value wherein a pinch-off voltage of the first J-FET transistor is less than a value of the second voltage value minus the first voltage value.

16. The method of claim 14 further including coupling a second current electrode of the second J-FET transistor, a gate of the second J-FET transistor, and a gate of the first J-FET transistor to receive the second voltage value of the voltage source and coupling a second current electrode of the first J-FET transistor to receive the first voltage value of the voltage source.

17. The method of claim 16 wherein the step of coupling the voltage source includes forming the first voltage value greater than the second voltage value.

18. The method of claim 14 further including forming the first J-FET transistor with a first width-to-length ratio that generates a first current flow through the first J-FET transistor and forming the second J-FET transistor with a second width-to-length ratio that generates a second current flow through the second J-FET transistor wherein the second current flow is substantially equal to the first current flow.

19. The method of claim 18 further including forming the second J-FET transistor with a length that limits thermal variations in the reference voltage to less than approximately five percent.
